(19) United States
(12) Patent Application Publication
(10) Pub. No.: US 2013/0234458 A1
(43) Pub. Date: Sep. 12, 2013

(54) ZIPPER PULLING TOOL

(71) Applicant: FOLLOW THRU, LLC, Santa Monica, CA (US)

(72) Inventor: YaVaughnie R. Wilkins, Santa Monica, CA (US)

(73) Assignee: FOLLOW THRU, LLC, Santa Monica, CA (US)

(21) Appl. No.: 13/776,697

(22) Filed: Feb. 25, 2013

Related U.S. Application Data
(60) Provisional application No. 61/603,167, filed on Feb. 24, 2012.

(51) Int. Cl. A47G 25/90; B25G 1/04

(52) U.S. Cl. CPC A47G 25/902; B25G 1/04
USPC 294/3.6; 16/429

(57) ABSTRACT

A zipper pull tool includes a telescoping handle with locking pins that enable each telescoping section of the handle to be locked in an extended or collapsed position. The tool may include a swivel mechanism between respective sections of the telescoping handle. A working end of a largest-diameter section of the telescoping handle may be connected to a spring clip for grasping a zipper or other article. The spring clip may fold away into an interior recess of the largest-diameter section, when the tool is not in use.

### CROSS-REFERENCE TO RELATED APPLICATION

This application claims priority pursuant to 35 U.S.C. §119(e) to U.S. provisional application Ser. No. 61/603,167, filed Feb. 24, 2012, which is hereby incorporated by reference in its entirety.

### BACKGROUND

1. Field

The present disclosure relates to a handheld tool adapted for pulling zippers in hard-to-reach places or having sliders that are difficult to manually grip.

2. Description of Related Art

Various zipper pull tools are disclosed in the patent literature. For example, U.S. Pat. No. 6,032,996 discloses a telescoping tool with a spring clip. Despite the advantages of prior art zipper pulls, opportunities exist for various improvements in function and design of such tools.

### SUMMARY

A zipper pull tool may include a telescoping handle comprising at least three sections of different diameters nested in sliding relationship to one another, a clamp attached adjacent to a first end of a largest-diameter section of the at least three sections, and resilient button assemblies. A respective one of the button assemblies may be attached adjacent to ends of at least two of the at least three sections. The camp may be, or may include, an alligator clip. The largest-diameter section may include an interior space holding the clamp in a folded position

The zipper pull tool may further include spring button receivers (e.g., through holes) at opposite ends of at least two of the at least three sections. The button receivers may be positioned in the at least three sections, such that each of the at least two sections is lockable in a collapsed configuration relative to another one of the at least three sections, using a receiver at a first end of the another one of the at least three sections. In addition, the button receivers may be positioned in the at least three sections, such that each of the at least two sections is lockable in an extended configuration relative to the another one of the at least three sections, using a receiver at a second end of the another one of the at least three sections. Thus, any one of the telescoping sections is lockable in an open or extending position relative to other sections of the tool handle.

The zipper pull tool may further include a swivel assembly interposed between the clamp and the largest-diameter section. The zipper pull tool may further include a swivel assembly interposed between at least two adjacent ones of the at least three sections, or a swivel assembly interposed between each of the at least three sections. The swivel assembly may include a friction fit swivel holding the swivel at any user-adjusted angle. The swivel assembly may provide rotation around two orthogonal axes of rotation.

Additional aspects and details of the zipper pull tool and its telescoping handle are provided in the detailed description below.

### BRIEF DESCRIPTION OF THE DRAWINGS

FIG. 1 is a side view of a first zipper pull tool in a collapsed configuration.

FIG. 2 is a side view of the first zipper pull tool, in an expanded configuration.

FIGS. 3A-3B show details a swivel joint between sections of the first zipper pull tool.

FIG. 4 is an isometric view of an alternative zipper clamp for a zipper pull tool.

FIG. 5 is a top view of the zipper clamp shown in FIG. 4.

FIG. 6 is a side view of the zipper clamp shown in FIG. 4.

FIGS. 7 is an isometric assembly view of an alternative zipper pull tool using the alternative zipper clamp.

Like element numerals are used to indicate like elements appearing in one or more of the figures.

### DETAILED DESCRIPTION

A zipper pull tool may assist persons to engage a back-side slider without the assistance of another person. This may benefit a person with limited mobility, etc., who would otherwise need the assistance of a helper to operate a zipper.

The described tool collapses to the approximate size of a ball-point pen (about 6 inches) and can therefore easily fit in a hand bag or the like. It may be constructed to extend as long as 3 feet in six-inch intervals. Each section of the telescoping handle may be swiveled in one or two axes to enable the user to easily maneuver the working end to the desired position.

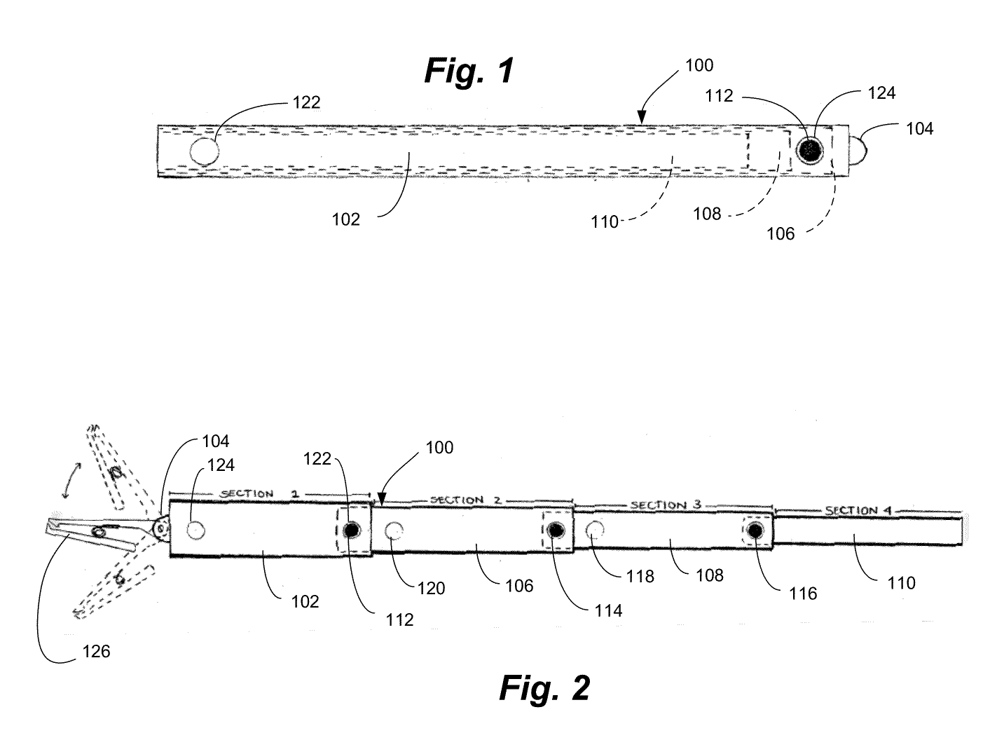

FIG. 1 shows a zipper pull tool 100 in a collapsed position. FIG. 2 shows the same tool 100 in and extended position, with the telescoping handle sections 102, 106, 108 and 110 fully extended. Referring to both FIGS. 1-2, a telescoping handle of the tool 100 may include nested tubes (sections) 102, 106, 108 and 110. A swivel mount 104 may join a clamp (e.g., alligator clip 126) to a first end of the largest-diameter section 102. The tube 102 may include an interior space into which the clamp 126 may be stored when not in use. The clamp may be detached from the swivel 104 and stored in the tube 102 as a separate piece, or swivel through an opening (not shown) into an interior of the tube 102.

Three of the sections 106, 108 and 110 may be coupled to respective resilient buttons 112, 114, 116, each of which locks to an opposing receiver, such as the holes 122 in section 102 when the handle is in an extended position, as shown in FIG. 2. When in a collapsed position, the buttons may lock into receivers at opposite ends of the respective sections, such as the hole 124 shown at the right end of section 102 in FIG. 1 and holes 124, 120, and 118 in FIG. 2. The sections 102, 106, 108 and 110 may constructed of aluminum or any other suitable lightweight structural material.

The zipper pull tool 100 may be operated by opening the clamp 126 and clipping onto the zipper tongue. To extend the tool, the user may push in and hold the first button 112 and pull out the second section 106 until the button 112 engages in the hole 124. Then, the button 114, which should be engaged in the receiver 120, may similarly be depressed to slide out the third section 108 to the position shown in FIG. 2. The last section 110 may similarly be extended if desired. Collapsing the tool is the reverse of extending.

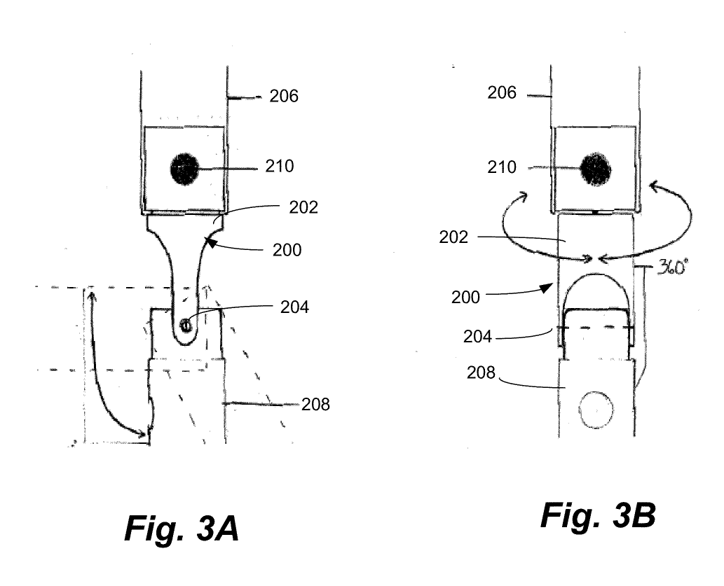

In some embodiments, joints between respective sections of the tool, and/or between the tool and the clamp, may be provided with a swivel assembly 200, as shown in FIGS. 3A-B. FIG. 3A shows the swivel assembly 200 in a front view, while FIG. 3B shows the assembly 200 in a side view. A clevis 202 may swivel around a handle section 206 as shown in FIG. 3B. A pin (not shown) may connect the clevis 202 to a lock assembly 210 to enable the clevis to rotate around the long axis of the tube section 206. A second pin 204 may couple to an adjacent section 208, enabling rotation of the section 208 around an axis perpendicular to the tube 206 longitudinal axis, as shown in FIG. 3A. The swivel pins (e.g., pin 204) may be press fit into their respective swivel pieces to provide enough friction to hold the adjacent sections 206, 208 at a desired angle during normal handling. The swivels may move and permit the handle to straighten when under tension. The telescoping handle may be provided with the swivel assemblies instead of, or in addition to, the sliding mechanism described in connection with FIGS. 1-2.

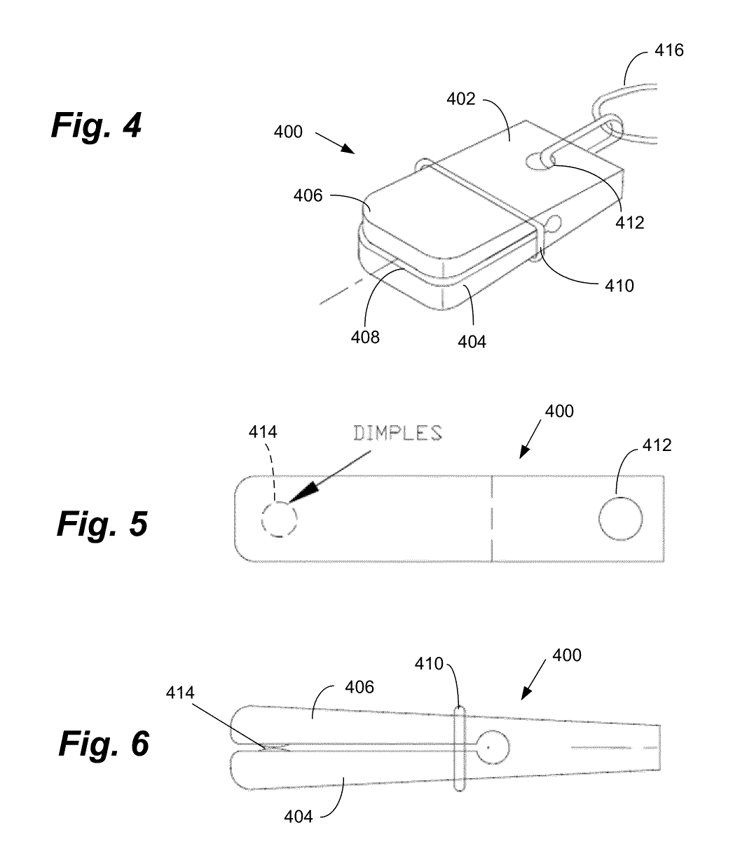

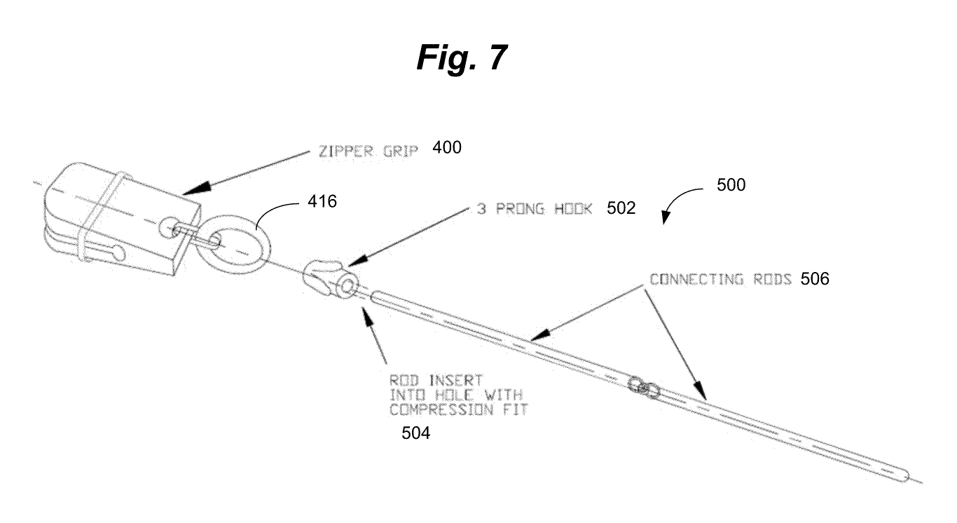

FIGS. 4-6 show various views of an alternative device 400 (clamp) for gripping the tongue of a zipper. If the tongue of the zipper has an opening or hole, then the dimples 414 will grip the hole in the tongue. A rectangular ring 410 may be provided in sliding relation to the exterior 402 of the grip to provide a locking action on a clamped zipper tongue. A slot 408 defines a resilient upper jaw 406 opposing the resilient lower jaw 404. A pair of dimples 414, teeth, roughened surfaces, or other features for gripping a zipper tongue may be placed between the jaws 406, 404. To use the device 400, the user first locks the clamp 400 on the tongue of the zipper, locking the clamp 400 in place by sliding the rectangular ring towards the dimples 414 until stopped by the taper of upper and lower jaws 406, 404. A ring 416 may be connected to the mounting mole 412 to facilitate grasping of the clamp by hand, with or without using an extension tool 500 (FIG. 7). The clamp 400 may be constructed of any suitable resilient structural material, for example, steel, aluminum, hard plastic, or a combination of such materials.

FIG. 7 illustrates how a 3 prong (or 4 prong) hook 502 of an extension tool 500 may enable a user to locate and connect with a ring 508 on the zipper grip. A round rod 506 may push into the hole 504 in the hook 502 using a compression fit. The hole 504 in the hook may include a compression seal member (for example, an o-ring) to keep the rod attached to pull the zipper.

An extension handle as illustrated in FIGS. 1-2 may be used, with or without an additional clamp to grasp the ring 416. On an alternative, a multi-prong hook 502 may also make it easy to grasp a ring 416 on the zipper grip 400 to pull on the zipper. The rod 506 is an extension device to reach the zipper grip device. The extension rod may be a telescoping tube as previously described, or several rods with a ring on the ends that are joined with a friction or ratchet pivot device to collapse the rods when not extended.

Having thus described an embodiment of a zipper pull tool, it should be apparent to those skilled in the art that certain advantages of the within system have been achieved. It should also be appreciated that various modifications, adaptations, and alternative embodiments thereof may be made without departing from the scope and spirit of the present technology. The scope of what is claimed should be determined by the appended claims interpreted in accordance with the foregoing specification, and is not limited by the examples hereinabove.

What is claimed is:

1. A zipper pull tool, comprising:
a telescoping handle comprising at least three sections of different diameters nested in sliding relationship to one another;
a clamp attached adjacent to a first end of a largest-diameter section of the at least three sections; and
resilient button assemblies, wherein a respective one of the assemblies is attached adjacent to ends of at least two of the at least three sections.

2. The zipper pull tool of claim 1, wherein the clamp comprises an alligator clip.

3. The zipper pull tool of claim 1, further comprising button receivers at opposite ends of at least two of the at least three sections.

4. The zipper pull tool of claim 3, wherein the button receivers are positioned in the at least three sections such that each of the at least two sections is lockable in a collapsed configuration relative to another one of the at least three sections, using a receiver at a first end of the another one of the at least three sections.

5. The zipper pull tool of claim 4, wherein the button receivers are positioned in the at least three sections such that each of the at least two sections is lockable in an extended configuration relative to the another one of the at least three sections using a receiver at a second end of the another one of the at least three sections.

6. The zipper pull tool of claim 1, further comprising a swivel assembly interposed between the clamp and the largest-diameter section.

7. The zipper pull tool of claim 1, further comprising a swivel assembly interposed between at least two adjacent ones of the at least three sections.

8. The zipper pull tool of claim 1, further comprising a swivel assembly interposed between each of the at least three sections.

9. The zipper pull tool of claim 1, wherein the swivel assembly includes a friction fit swivel holding the swivel at any user-adjusted angle.

10. The zipper pull tool of claim 1, wherein the largest-diameter section includes an interior space holding the clamp in a folded position.

11. A telescoping handle for a zipper pull tool, the handle comprising:
at least three sections of different diameters nested in sliding relationship to one another;
resilient button assemblies, wherein a respective one of the assemblies is attached adjacent to ends of at least two of the at least three sections; and
button receivers at opposite ends of at least two of the at least three sections.

12. The telescoping handle of claim 11, wherein the button receivers are positioned in the at least three sections such that each of the at least two sections is lockable in a collapsed configuration relative to another one of the at least three sections, using a receiver at a first end of the another one of the at least three sections.

13. The telescoping handle of claim 12, wherein the button receivers are positioned in the at least three sections such that each of the at least two sections is lockable in an extended configuration relative to the another one of the at least three sections using a receiver at a second end of the another one of the at least three sections.

14. The telescoping handle pull tool of claim 11, further comprising a swivel assembly interposed between at least two adjacent ones of the at least three sections.

15. The telescoping handle pull tool of claim 11, further comprising a swivel assembly interposed between each of the at least three sections.

16. The telescoping handle pull tool of claim 11, wherein the swivel assembly includes a friction fit swivel holding the swivel at any user-adjusted angle.
